(19) United States
(12) Patent Application Publication
(10) Pub. No.: US 2024/0212488 A1
(43) Pub. Date: Jun. 27, 2024

(54) INTELLIGENT SPEED CHECK

(71) Applicant: CARIAD SE, Wolfsburg (GE)

(72) Inventors: Tino REMUS, Mountain View, CA (US); Christian LORENZ, Discovery Bay, CA (US); Josephine NITSCHKE, Pacifica, CA (US)

(21) Appl. No.: 18/086,192

(22) Filed: Dec. 21, 2022

(51) Int. Cl. G08G 1/052; G08G 1/017

(52) U.S. Cl. CPC G08G 1/052; G08G 1/017

(57) ABSTRACT

One or more sets of velocity and vehicle data originating from one or more vehicles traversing a road segment are collected. The one or more sets of velocity data are analyzed to generate speed check analytical data for the road segment. A speed check zone on the road segment is identified based at least in part on the speed check analytical data.

### TECHNICAL FIELD

Embodiments relate generally to vehicle systems, and, more specifically, to intelligent speed check in operating vehicle systems.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Navigation systems nowadays are used in operations of vehicle systems as a matter of routine. These navigation systems may be relied on by vehicle operators and/or passengers to plan trips and help navigate safely in realtime on various routes between or among origination locations, waypoints, destination locations, etc. On a route determined with a navigation system, there may exist a number of natural and/or artificial hazards or road conditions from time to time. It is desirable that such navigation system provides accurate and timely information about these hazards and conditions including any possible speed traps or speed check zones and events.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 illustrates an example framework for generating speed check data relating to operations of vehicles;

FIG. 2 illustrates an example velocity data analyzer;

FIG. 3A illustrates example road segments; FIG. 3B and FIG. 3C illustrate example plots of collected velocity data;

FIG. 4 illustrates an example process flow; and

FIG. 5 is block diagram of a computer system upon which embodiments of the disclosure may be implemented.

### DETAILED DESCRIPTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure.

Embodiments are described herein according to the following outline:
1.0. General Overview
2.0. Structural Overview
   2.1. Speed Check Data Collectors
   2.2. Speed Check Data Analyzers
   2.3. Speed Check Analytical Data Fusion
   2.4. Speed Check Data Output
3.0. Functional Overview
   3.1. Road Segmentation
   3.2. Speed Check Data Collection
   3.3. Speed Check Data Analyses
   3.4. Speed Check Detection
4.0. Example Process Flows
5.0. Implementation Mechanism-Hardware Overview
6.0. Extensions and Alternatives

### 1.0. General Overview

As used herein, a speed check event may refer to an event of speed check (or monitoring) existing, happening or occurring on a specific portion of a road. The event may last from a starting time to an ending time. For example, the speed check zone event may occur or last from a first time point at which the police car is detected on the road to a second time point at which the police car is detected as having left the road.

The specific portion of the road on which the event is happening may be referred to a speed check zone. The speed check zone may be static and delimited (or predicted/estimated) with a specific start location and a specific end location on the road that are constant or fixed over the duration of the speed check zone event. For example, a police car may be parked at a fixed location monitoring and attempting to enforce an applicable speed limit at a specific relatively fixed spatial section of the road. A speed check zone event occurs or lasts from a first time point at which the police car is detected at the fixed location to a second time point at which the police car is detected as leaving the fixed location. The specific section of the road monitored and/or enforced (with the applicable speed limit) by the police car represents a static speed check zone.

The speed check zone may be dynamic and not delimited with fixed or constant start and end locations on the road over the duration of the speed check zone event. For example, a police car may be moving on the road observing, monitoring and attempting to enforce an applicable speed limit on the road. The specific section of the road monitored and/or enforced (with the applicable speed limit) by the police car represents a dynamic speed check zone composed of rear and front subsections (e.g., a one-mile road section at the center of which is the police car, etc.) of the road in relation to, and varying with the contemporaneous location of, the police car.

Under other approaches, identification data for speed check zones or events is typically or wholly generated manually from inputs provided by a user community—e.g., of a navigation or map application such as Waze, etc.—or with the help of radar detectors in vehicles. The user community based speed check zone or event detection may need manual reports and active participation of a relatively large active user base to operate accurately and timely. The radar detectors may be prone to ambient interferences and signals unrelated to speed monitoring activities and hence unable to accurately and timely detect speed check zones or activities. In addition, radar detectors are not common and can only detect a small sample among relatively frequent occurrences of speed check zones or activities.

In contrast, techniques as described herein can be implemented to accurately and timely learn or detect speed check zones with driving behaviors of a relatively small set or number of cars or users. These techniques can generate and utilize a relatively rich set of different types of data points from the relatively small set or number of vehicles or users. The relatively rich set of different types of data points can be collected and analyzed at the backend with a variety of analysis algorithms to timely and accurately detecting speed check zones or events.

Analytical data can be generated from the different types of data points by a navigation or map application/server at the backend for speed check zones or events on various roads. Some or all analytical data relating to detected speed check zones or events may be provided to in-vehicle navigation or map applications/systems (e.g., mobile applications on mobile device, embedded applications of in-vehicle systems, etc.). The analytical data may be used to support, or may be incorporated by the in-vehicle navigation or map applications/systems into, navigation features, for example to provide reliable, intelligent and timely information and warnings relating to the detected speed check zones or events in realtime to users or vehicles. In addition, the analytical data can be used in system features relating to popups, no visual MAP integration, etc.

In some operational scenarios, the navigation or map application/server represents a cloud-based or remote navigation server/system/aggregator that collects a variety of data from a variety of data sources. The data collected may include, but are not necessarily limited to only, any, some or all of: map data, road data, weather data, traffic data, vehicle velocity data, manual input data, image (recognition) data, braking (behavior) data, and so on. Some or all of the data may be collected based on one or more data collection schedules to provide a relatively high temporal resolution such as every 3 to 5 minutes or less while some of the data may be collected on demand, upon user input events and/or braking events, etc. Different machine-learning (ML) and/or non-ML analysis algorithms can be applied to different types of data or data points to generate multiple respective predictions or estimations of any presences of speed check zones or events with different levels of confidence. These multiple predictions or estimations of different levels of confidence may be aggregated, fused or correlated to generate an overall prediction or estimation of speed check zones or events with a relatively high overall level of confidence.

With accurate and timely identifications and detections of speed check zones or events, users or vehicles are enabled to adapt driving styles or behaviors timely, safely, manually and/or automatically in response to dynamic road conditions, thereby growing or increasing user popularity and impact over time.

Approaches, techniques, and mechanisms are disclosed for detecting speed check events or zones. One or more sets of velocity data originating from one or more vehicles traversing a road segment are collected. Each set of velocity data in the one or more sets of velocity data originates from a respective vehicle in the one or more vehicles. The one or more sets of velocity data are analyzed to generate speed check analytical data for the road segment. A speed check zone on the road segment is identified based at least in part on the speed check analytical data.

In other aspects, the disclosure encompasses computer apparatuses and computer-readable media configured to carry out the foregoing techniques.

### 2.0. Structural Overview

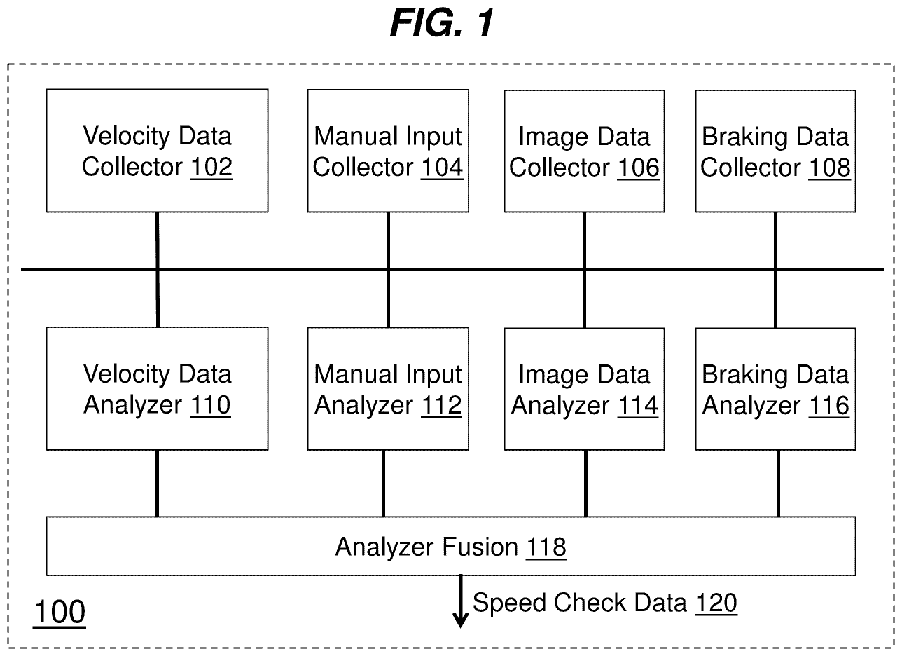

FIG. 1 illustrates an example framework 100 for generating speed check data relating to operations of vehicles. The framework (100) comprises one or more data collectors such as a velocity data collector 102, a manual input (data) collector 104, an image (e.g., recognition, etc.) data collector 106, a braking (behavior) data collector 108, etc.; one or more data analyzers such as a velocity data analyzer 110, a manual input (data) analyzer 112, an image (e.g., recognition, etc.) data analyzer 114, a braking (behavior) data analyzer 116, etc.; a (data) analyzer fusion block 118; etc. The framework 100 or subsystem(s) therein may be implemented with some or all of: artificial intelligence or AI techniques, machine learning or ML techniques, non-AI non-ML techniques, a combination of different types of computing techniques, etc. Each block, module, device, system, etc., illustrated in the framework 100 may be collectively or individually implemented with one or more computing devices that comprise any combination of hardware and software configured to implement the various logical components described herein. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

### 2.1. Speed Check Data Collectors

The data collectors of the framework 100 may interact, interface or otherwise operate in conjunction with (data collection) computer applications installed or deployed on mobile devices collocated in one or more vehicles traversing one or more roads or segments thereof. These computer applications may be mobile applications (or mobile apps) running on the mobile devices collocated with the vehicles and represent in-vehicle data collection agents to the data collectors of the framework 100. The data collectors of the framework 100) can operate with the in-vehicle computer applications or data collection agents to collect different varieties or types of data from these vehicles in real time or in near real time.

The velocity data collector 102 may obtain vehicle velocity related data from one or more of: one or more third party or non-third-party map applications running on the mobile phones and/or the vehicles; one or more subsystems implemented with the mobile phones and/or the vehicles; etc. Some or all of the collected vehicle velocity related data may be generated with or originated from one or more positional, orientational, motion, GPS sensors, etc., installed on the mobile phones and/or deployed in the vehicles. Some or all velocity data of a vehicle may be collected or originated from the vehicle itself or from mobile devices in the vehicle that have GPS tracking enabled. Additionally, optionally or alternatively, city infrastructure cameras and physical sensors (e.g., image sensors, range sensors, LIDARs, RADARs, etc.) outside one or more vehicles may be used to individual velocities or speeds of the vehicles. These city cameras or sensors can be located along streets/roads and used to detect or monitor velocities/speeds of vehicles traveling on the streets/roads. These cameras or sensors can be used to collect velocity data of vehicles or sensory data for inferring or generating the velocity data of the vehicles and/or for detecting presences of police cars or speed check events/activities/zones.

The manual input (data) collector 104 may obtain manual input/reporting data from one or more of: one or more third party or non-third-party map applications running on the mobile phones and/or the vehicles; one or more subsystems such as human-machine interfaces or man-machine interfaces implemented with the mobile phones and/or the vehicles; etc.

The image (recognition) data collector 106 may obtain image related data from one or more of: one or more third party or non-third-party map applications running on the mobile phones and/or the vehicles; one or more image or other sensors (e.g., cameras, image sensors, LIDAR sensors, RADAR sensors, etc.) implemented with the mobile phones and/or the vehicles; one or more subsystems implemented with the mobile phones and/or the vehicles; etc. Some or all of these sensors can be used to not just monitor their own speeds of the vehicles, but also speeds of the surrounding traffic in both lanes traveled by the vehicles as well as neighboring lanes.

The braking (behavior) data collector 108 may obtain braking related data from one or more of: one or more third party or non-third-party map applications running on the mobile phones and/or the vehicles; one or more positional or motion sensors implemented with the mobile phones and/or the vehicles; one or more pressure or force sensors implemented with vehicles to monitor forces with timing information exerted on the brake pedals; braking related information or data retrieved from the velocity data collector; one or more subsystems implemented with the mobile phones and/or the vehicles; etc.

### 2.2. Speed Check Data Analyzers

The data analyzers of the framework 100 may receive and analyze some or all of the collected data from the data collectors of the framework 100. Some or all of these data analyzers may implement and/or apply machine learning algorithms—which may have been trained and tested by lab data or previously collected data of the same types with ground truth (labels)—to the collected data and predict, estimate or detect speed check zones. Some or all of these data analyzers may implement and/or apply non-ML algorithms using decision paths, loops, recursive and/or iterative steps, rules and/or program logics to the collected data and predict, estimate or detect speed check zones.

The velocity data analyzer 110 may implement ML and/or non-ML algorithms to analyze vehicle velocity related data collected for vehicles traversing on a given road segment during a time interval (e.g., every three or five minutes, etc.) to generate predictions, estimations or detections of speed check zones present in the time interval on the road segment.

The velocity data analyzer 110 may analyze the vehicle velocity related data to determine or generate distributions of the vehicles' velocities at multiple locations of a road segments to determine, identify or recognize specific patterns—e.g., velocities converge close to an applicable speed limit of the road segment, etc.—in the velocity distributions. Some or all of these recognized patterns in the velocity distributions indicate a candidate speed check zone or event on the road segment—or a likelihood of a presence of a speed check zone or event on the road segment.

The velocity data analyzer 110 may analyze the vehicle velocity related data to determine or generate individual velocity histories of multiple vehicles one the road segments to determine, identify or recognize specific patterns—e.g., a vehicle previously traveling at a speed ten miles above an applicable speed limit is now traveling at close to the applicable speed limit, etc.—in the velocity histories. Some or all of these recognized patterns in the velocity histories indicate a candidate speed check zone or event on the road segment—or a likelihood of a presence of a speed check zone or event on the road segment.

The velocity data analyzer 110 may analyze the vehicle velocity related data to determine, identify or detect vehicle pullover events. For example, a vehicle leaves a traveling lane to stop at shoulder or exit ramp for a specific range or duration of time but move again may be detected or recognized as a vehicle pullover events. Additional detection of a police car next to the vehicle may be used or incorporated by the data analyzers of the framework 100 to raise or increase (e.g., relatively significantly, 90%, 95%, etc.) the confidence level of the detection/recognition of the vehicle pullover event. Both supervised and non-supervised ML algorithms can be used or implemented in the data analyzers. In the case of supervised ML algorithm, these ML algorithms may be trained beforehand in a training phase with labeled (with ground truth) training data in using input features such as locations of stopped vehicles and/or durations of vehicle stopping and/or other factors to make detections or recognitions of vehicle pullover events. Operational parameters such as weights and/or biases of artificial neural networks (ANN) may be optimized through training. The same ML algorithms or neural networks with these optimized parameters may be deployed in the data analyzers. In some operational scenarios, at least some of the ML algorithms or neural networks are deployed with in-vehicle applications/systems to accomplish at least some operations associated with detecting or recognizing vehicle pullover events.

The manual input (data) analyzer 112 may implement ML and/or non-ML algorithms to analyze manual input data collected for vehicles traversing on a given road segment during a time interval (e.g., every three or five minutes, etc.) to generate predictions, estimations or detections of speed check zones present in the time interval on the road segment. In response to receiving the manual input data indicating user report(s) of a presence of police vehicle(s) and/or speed check or monitoring activities on the road segment, the manual input analyzer 112 can assign a relatively high confidence level to a detection of a presence of a speed check zone or event on the road segment. However, in some operational scenarios, the manual input data collected for the time interval from users of vehicles traversing the road segment may not indicate any user report, as these users are not obligated to report sightings of police cars or speed check or monitoring activities. Hence, in some operational scenarios, the manual input data may be null or otherwise indicate no user report of these sightings or activities. Additionally, optionally or alternatively, the manual input data may include other types of user reports for traffic conditions such as traffic jams and road construction activities, debris, detours, etc. These other types of user reports may also be used, for example in conjunction with the presence or absence of user reports indicating police or speed monitoring activities, by the data analyzers to detect or rule out a speed check zone or event on the road segment in the time interval. In some operational scenarios, reports or inputs from users that were frequently (e.g., always, etc.) false—e.g., because they were trying to interfere with the system or its operations—may be excluded or filtered out by the system, especially when there are multiple occurrences in which a user who provided a false user input was the only input source (with no other types of data or other user inputs to corroborate).

The image (recognition) data analyzer 114 may implement ML and/or non-ML algorithms to analyze image data collected for vehicles traversing on a given road segment during a time interval (e.g., every three or five minutes, etc.) to generate predictions, estimations or detections of speed check zones present in the time interval on the road segment. In response to receiving the image data indicating user report(s) of a presence of police vehicle(s) on the road segment, the image data analyzer 114 can assign a relatively high confidence level to a detection of a presence of a speed check zone or event on the road segment. Some or all of the vehicles may be equipped with cameras or image/range sensors at front, side, rear and/or other locations. Police car recognition algorithms may be implemented by the data analyzers and/or by in-vehicle applications or systems using ML-based or non-ML computer vision techniques such as convolutional neural networks. In some operational scenarios, raw image data or range data collected by the cameras or sensors be a relatively large data volume. To reduce payloads in data communications and/or to protect user privacy, the raw image data or range data may be analyzed by in-vehicle applications or systems first to determine whether a police car is present in a driving lane or on a shoulder of the road segment or whether a stopped car is on the shoulder. For example, convolutional neural networks with trained or optimized operational parameters (generated in a training phase) may be deployed (in an application phase) with the in-vehicle applications or systems of some or all of the vehicles traversing the road segments to analyze raw image and/or range data collected in situ to determine any presence of police car and/or stopped car and/or other traffic events. In response to determining that reportable observations are indicated in the raw image and/or range data, corresponding image and/or analytical data specifying or describing these reportable observations may be uploaded to a cloud-based or remote backend system that implements the framework 100. The image (recognition) data collected for the time interval from the vehicles traversing the road segment may not indicate any reportable observations. Hence, in some operational scenarios, the image (recognition) data may be null or otherwise unavailable to the data analyzers. Additionally, optionally or alternatively, the image data may include other types of reportable observations for traffic conditions such as traffic jams and road construction activities, debris, detours, etc. These other types of reportable events may also be used, for example in conjunction with the presence or absence of reportable events indicating police presence, by the data analyzers to detect or rule out a speed check zone or event on the road segment in the time interval.

The image data and/or other vehicle operational sensor data acquired or collected by built-in vehicle systems therein, for example over in-vehicle controller area networks (CANs), ethernet (ETH), FlexRay (FR), local interconnect network (LIN), media oriented systems transport (MOST), CAN flexible data-rate (CANFD), etc., may be used to determine relatively precise locations (e.g., which specific lane, any lane change movement, etc.) and directions (e.g., aligned with the lane direction, deviated from the lane direction, etc.) of vehicles relatively to a given road segment on which the vehicle is moving. These locations and/or directions can be determined by the vehicles or built-in vehicle systems based at least in part on GPS data collected by the built-in vehicle systems, and can be (significantly, etc.) more precise than locations or directions determined using mobile device acquired GPS data. For example, built-in vehicle system determined (GPS) locations and/or directions may be used to precisely indicate whether a vehicle is inside a normal traffic lane or has left the normal traffic lane, for example to a shoulder of a road segment or an exit ramp, or whether the car is moving or has stopped. As a result, it is reasonable to expect that predictions of speed check zones or events based on built-in system collected data may be more precise (or assigned a higher confidence level) than predictions based on mobile device collected data.

The braking (behavior) data analyzer 114 may implement ML and/or non-ML algorithms to analyze braking data collected for vehicles traversing on a given road segment during a time interval (e.g., every three or five minutes, etc.) to generate predictions, estimations or detections of speed check zones present in the time interval on the road segment. In response to receiving the braking data indicating relatively hard braking operations in a relatively short time in some or all of the vehicles, the image data analyzer 114 can assign a corresponding confidence level to a detection of a presence of a speed check zone or event on the road segment. Operational states or events (e.g., on, off, etc.) of braking systems can be collected in in-vehicle sensors incorporated in the vehicles. These operational states or events can be collected through in-vehicle data communication networks such as controller area networks (CAN) deployed with the vehicles or vehicle systems and reported to the backend system implementing the framework 100. Braking behavior analysis algorithms may be implemented by the data analyzers and/or by in-vehicle applications or systems using ML-based or non-ML inference/prediction techniques such as artificial neural networks. In some operational scenarios, input features may be extracted from the braking data and used by the braking behavior analysis algorithm (e.g., with learned or optimized operational parameters, etc.) to predict whether certain braking behaviors responsive to the presence of speed check or police car have occurred on the road segment in the time internal.

### 2.3. Speed Check Analytical Data Fusion

Speed check analytical results and/or individual predictions and/or individual confidence levels from some or all of the ML (e.g., deep neural networks, etc.) and/or non-ML (e.g., rule based, procedure based, program logic based, deterministic, etc.) algorithms implemented in the data analyzers of the framework 100 can be combined or fused together using ML or non-ML data fusion algorithms to generate or derive a final prediction with a final confidence level of whether a speed check zone or event is present at a given road segment in a given time interval. The higher each of the individual confidence level is, the higher the overall or final confidence level will be.

The data fusion algorithms can assign different weights to different data analyzers or predictions based on different types or combinations of data or data points. These weights may be pre-assigned or dynamically configurable. Additionally, optionally or alternatively, these weights may be learned or trained in cases that the data fusion algorithms are implemented with ML-based prediction models and/or techniques. Hence, even if a particular individual prediction from a particular prediction algorithm/model may be of a relatively low confidence level (due to a relatively small set of data or data points), an overall or final confidence level for a resultant or final prediction may be relatively high, for example where the particular individual prediction is determined to be relatively strongly correlated with another individual prediction from another prediction algorithm/model with or without a relatively high confidence level.

### 2.4. Speed Check Data Output

The backend system implementing the framework 100 can generate and send alerts for speed check zones or events over one or more computer networks to end user map or navigation applications or devices. The timeliness of these alerts may depend on the spatial and/or temporal resolution/granularity of the collected data as well as time latency involved in collecting, transmitting and processing the data and in sending these alerts to the end user applications or devices. Backend detected events can be pushed to or pulled by vehicles to alert users of the vehicles audibly or visually through in-vehicle applications/systems.

As used herein, an alert for speed check may refer to a message generated and sent by the backend system to an end user map or navigation application or device to inform a presence or absence of a speed check zone or event. The alert may be used by the backend system or the end user application or device to present or release visual, audio, graphic and/or textual warning(s) or information.

For example, in response to receiving an alert for a presence of a speed check zone or event, a red color coded graphic indicator of a specific shape may be displayed on a display page or image display of the end user application or device. Additionally, optionally or alternatively, a relatively high pitched audio sound may be played (back) by the end user application or device. Additionally, optionally or alternatively, haptic vibrations in seat or steering wheel may be triggered. Additionally, optionally or alternatively, an interactive UI may be used to provide feedback on presence/absence of a speed check event or zone. Additionally, optionally or alternatively, traffic color coding may be used or shown in displayed maps—for example, the route segment on which the speed check event is present may be marked with a worm-like graphic line segment.

In response to receiving an alert for a release or end of a speed check zone or event, a green coded graphic indicator of a specific shape may be displayed on a display page or image display of the end user application or device. Additionally, optionally or alternatively, a relatively soothing audio sound may be played (back) by the end user application or device. Additionally, optionally or alternatively, any of these user perceivable feedbacks to signal ends of speed check events or zones may be omitted, left out or otherwise excluded by a system as described herein in order not to encourage speeding.

### 3.0. Functional Overview

In an embodiment, some or all techniques and/or methods described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### 3.1. Road Segmentation

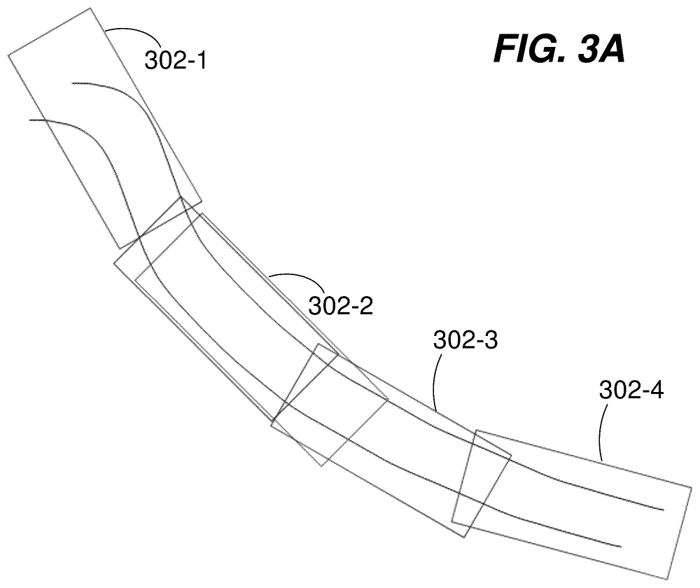

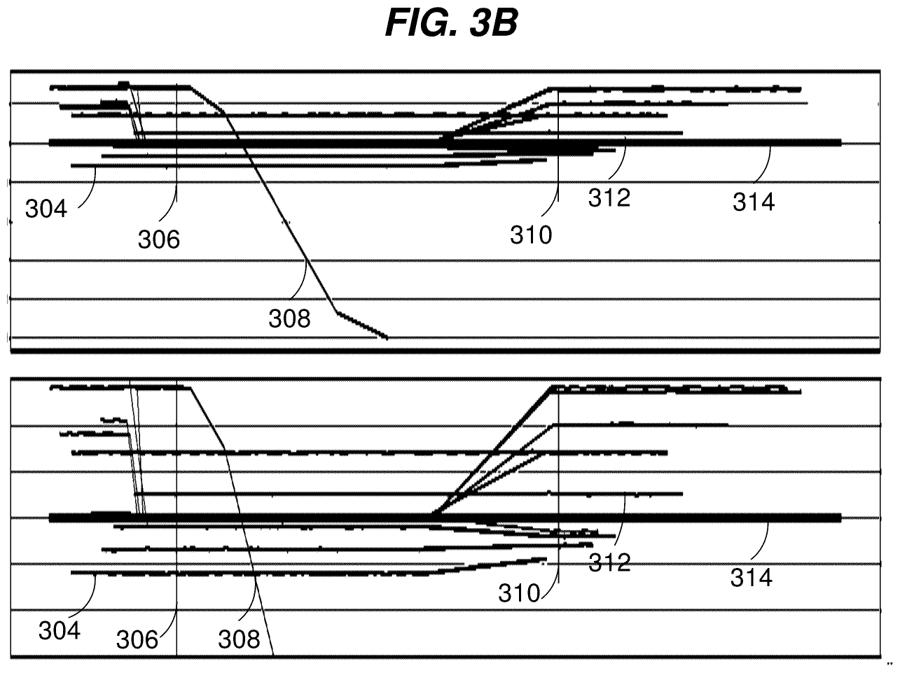

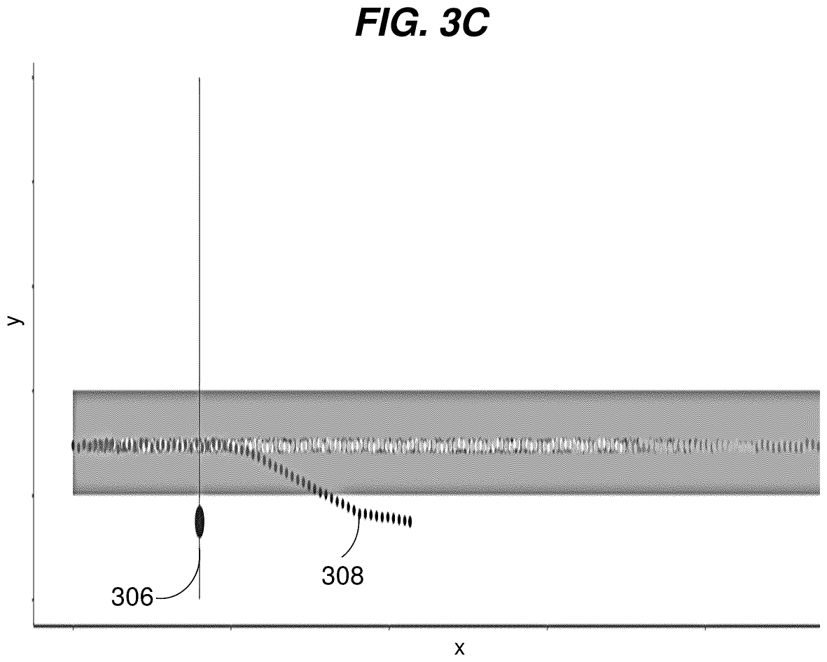

FIG. 3A illustrates example road segments 302-1 through 302-4 of a road as described herein. As shown, the road may be segmented or discretized into different sections. In some operational scenarios, these road segments 302 may be mutually exclusive. In some operational scenarios, at least two adjacent road segments 302 may be partially overlapped. The road segments may be adjusted or changed to different granularities or lengths over time. For example, road segments used for nighttime speed check detection on a road may be different from road segments of the same road used for rush hour speed check detection.

Where the road is straight, the different sections of the road may represent straight road segments with longitudinal or lengthwise directions indicating lane directions (or normal vehicle traveling directions). Where the road is curved, these different sections of the road may be approximated by relatively straight road segments with longitudinal or lengthwise directions indicating average or approximated lane directions (or normal vehicle traveling directions). Additionally, optionally or alternatively, other types of 1D, 2D or 3D spatial shapes including but not limited to curved segments, clothoids, etc., may be used by a system described herein to approximate sections of the road in addition to or instead of straight line segments.

These road segments may or may not have the same lengths (along the lane directions) or widths (traverse to the lane directions) or granularities. In some operational scenarios, a curved road may be segmented with different lengths or granularities from a straight road. A highway may be segmented with different lengths or granularities from a local street.

Specific map or street related data (e.g., the road is curved or straight, the road is uphill or downhill, time constant or time varying speed limit, etc.) and/or speed check data (e.g., velocity data, manual input data, image data, braking data, etc.) and/or local traffic data and/or local weather can be collected by the data collectors of the framework 100 with respect to these road segments on one or more data collection schedules (e.g., every three or five minutes, etc.) and/or on demand and/or when certain events or conditions occur.

The data analyzers of the framework 100 may or may not apply the same algorithms and/or the same operational parameters in analyzing collected data on different road segments and/or different road types and/or different input road descriptors or parameters (e.g., indicating road types, road geometries, etc.). For example, on a curved non-highway road, vehicle slowing down may be normal expected behaviors and have nothing to do with any presence or absence of a speed check zone or event. In comparison, on a straight road or a highway, vehicle slowing down may be abnormal behaviors and may indicate a presence of a speed check zone or event. Hence, input road descriptors or parameters as collected or received by the framework 100 may be used by the data analyzers to adapt the analysis algorithms or operations.

In some operational scenarios, collected data in multiple road segments may be analyzed together. In an example, as a police car moves after pulling a vehicle out, a (moving) speed check zone/event—representing a sliding window—may be detected and recognized for multiple road segments. In another example, a speed check zone/event may, or may be detected or recognized to, start at a first road segment (e.g., at or after a first time point, etc.), as most vehicles are detected to exhibit similar behaviors to slowing down from ten miles above the speed limit to close to the speed limit at a specific location of the first road segment. The speed check zone/event may, or may be detected or recognized to, end at a second different road segment (e.g., after some time lapses, etc.), as most vehicles are detected to exhibit similar behaviors to slowing down from close to the speed limit back to ten miles above the speed limit at a second specific location of the second road segment.

### 3.2. Speed Check Data Collection

In some operational scenarios, the framework 100 may be implemented or operated by one or more manufacturers (e.g., Volkswagen, Audi, Porsche, etc.) of a relatively large fleet of vehicles. In some operational scenarios, the framework 100 may be implemented or operated by a navigation or map service provider. At any given time, a relatively large number of vehicles may be operated by a relatively large number of users or drivers in various parts of a geographic area such as a nation, a state, a region, a city, a town, a highway section, local roads, etc.

Some or all of velocity, manual input, image (recognition), braking (behavior) and/or other data (e.g., mapping data, road data, traffic hazard data, weather data, speed check zone related information, etc.) may be collected by in-vehicle data collection agent such as software and/or hardware implemented modules/devices deployed in the vehicles. The data collection agents can be operatively linked with the framework 200 or the data collectors therein to provide the velocity, manual input, image (recognition), braking (behavior) and/or other data for further analyses.

Additionally, optionally or alternatively, some or all of the velocity, manual input, image (recognition), braking (behavior) and/or other data (e.g., mapping data, road data, traffic hazard data, weather data, speed check zone related information, etc.) may be collected by the framework 200 from third party vehicles or their backend systems or from third party map or navigation applications or systems (e.g., map or navigation applications installed or provided by a mobile device maker, map or navigation applications installed or downloaded from a cloud-based application provider, map or navigation applications relating to taxi services, etc.) through one or more data communication links over one or more computer networks. In an example, mobile apps for mapping and/or navigation running on mobile devices in vehicles may share map and/or navigation related data with the in-vehicle data collection agents on the same mobile device or separate vehicle-based systems (e.g., wirelessly, via wire-based data connections, through USB connections, etc.). In another example, the framework 100 may interface with (e.g., cloud-based, etc.) map/navigation application servers for these mobile applications and obtain map and/or navigation data from these application servers.

Some or all of the data as described herein can be collected periodically such as every fifteen minutes, every five minutes, every three minutes, etc. Different types of data may be collected with different schedules. At least some of the data may be collected on demand or upon specific events and/or locations (e.g., user input events, braking pushing and/or releasing events, police car presence, speed trap locations, etc.) across a relatively large geographic area. These schedules for collecting various types of data for analysis can be pre-configured beforehand and dynamically or adaptively changed based at least in part on one or more scheduling factors such as responsiveness, intended temporal spatial and/or resolution to be achieved, computational and/or memory space costs, etc.

Example velocity related data as described herein may include, but not necessarily limited to only, any, some or all of: GPS coordinates, vehicle velocities, vehicle heading or directions, map matched data (e.g., road geometry, road type, speed limit, time varying traffic information, local hazard warning, local weather, etc.), and so on.

Timing and/or locational data may be contemporaneously collected in realtime or near realtime with the velocity related data and may be included as a part of the velocity related data. The timing data may include timestamps indicating specific time points at which specific portions of the velocity related data are measured. The locational data may include spatial locations and/or directions (e.g., GPS coordinates, vehicle velocities, vehicle heading or directions, etc.) of the vehicles in which specific portions of the velocity related data are measured.

At least some of the velocity related data may be collected relatively frequently in a sequence of successive time points spanning over a time window or duration at a specific time resolution/precision and used to generate a relatively large number of sets of data points corresponding to respective time points in the sequence of successive time points. These different sets of data points for different time points may be (e.g., collectively, etc.) used to determine, estimate or predict any speed check zones or events in the road segments within the time window or duration. The more the sets of data points (e.g., the more the vehicles, the more the time points, etc.), the higher the confidence level for speed check zone predictions generated from these sets of data points.

Example manual input/reporting data as described herein may include, but not necessarily limited to only, any, some or all of: user inputs indicating user observations of police activities, user inputs indicating traffic or speed check alerts, user inputs indicating user observations of road hazards, user inputs indicating user observations of traffic accidents, etc.

Timing and/or locational data may be contemporaneously collected in realtime or near realtime with the user inputs and may be included as a part of the manual input/reporting data. The timing data may include timestamps indicating specific time points at which the user inputs are made. The locational data may include spatial locations and/or directions (e.g., GPS coordinates, vehicle velocities, vehicle heading or directions, etc.) of the vehicles in which the (reporting) users are located.

The manual input/reporting data may include a relatively small number of sets of data points. The relatively small number of sets of data points may be individually or collectively used to determine, estimate or predict any speed check zones in the road segments within a time window or duration with relatively high confidence levels for speed check zone predictions generated from these sets of data points.

Example image related data as described herein may include, but not necessarily limited to only, any, some or all of: images captured by in-vehicle cameras or image sensors, point clouds generated by in-vehicle range sensors, information about police vehicles recognized or detected based at least in part on the acquired images and/or range data, etc.

Timing and/or locational data may be contemporaneously collected in realtime or near realtime with the image related data and may be included as a part of the image related data. The timing data may include timestamps indicating specific time points at which the images or point clouds are made. The locational data may include spatial locations and/or directions (e.g., GPS coordinates, vehicle velocities, vehicle heading or directions, etc.) of the vehicles in which the image or range sensors are located.

The image related data may include a relatively small number of sets of data points. The relatively small number of sets of data points may be individually or collectively used to determine, estimate or predict any speed check zones in the road segments within a time window or duration with relatively high confidence levels for speed check zone predictions generated from these sets of data points.

In an example, a picture or image acquired with an in-vehicle camera may be analyzed with computer vision techniques including but not limited to those implemented with artificial neural networks, convolutional neural networks, deep neural networks, etc., to recognize or detect the presence of one or more police cars or police motorcycles, to determine whether these cars or motorcycles are next to a road, street or highway section, etc. If so, a stationary speed check zone may be detected. In another example, a sequence of successive pictures or images acquired with an in-vehicle camera may be analyzed with computer vision techniques to determine whether a police car or motorcycle moves around one or more non-police cars or vehicles. If so, a moving speed check zone may be detected.

Some or all computer vision techniques as described herein may be implemented or performed by a cloud-based or remote computer device or image data analyzers therein that receive captured images or range data (e.g., successive sets of point clouds, etc.) from in-vehicle image or range sensors. Additionally, optionally or alternatively, some or all computer vision techniques described herein may be implemented or performed by one or more local or in-vehicle computer device or image data analyzers collected with the vehicles. The image analyzers can receive captured images or range data (e.g., successive sets of point clouds, etc.) locally from in-vehicle image or range sensors, perform image analysis and police car detection/recognition on the captured images or range data, and provide some or all analytical results to other computing systems or devices—e.g., one or more modules/devices/blocks that implement the speed check zone detection framework 100, etc.—remotely located from the vehicles.

Example braking related data as described herein may include, but not necessarily limited to only, any, some or all of: car or vehicle data generated by the vehicles relating to braking pedal operations (e.g., brake tapping, brake light going on and off, brake push, brake release, accelerator push, accelerator release, etc.), motion information generated based on positional or motion sensor data, etc.

Timing and/or locational data may be contemporaneously collected in realtime or near realtime with the braking related data and may be included as a part of the braking related data. The timing data may include timestamps indicating specific time points at which specific braking operations are made. The locational data may include spatial locations and/or directions (e.g., GPS coordinates, vehicle velocities, vehicle heading or directions, etc.) of the vehicles with which specific braking operations are performed.

The braking related data may include a number of sets of data points. The sets of data points may be individually or collectively used to determine, estimate or predict any speed check zones in the road segments within a time window or duration with relatively high confidence levels for speed check zone predictions generated from these sets of data points.

For example, a speed check zone may be determined or detected in response to determining that all or substantially all (e.g., a majority of, 90%, 95%, etc.) vehicles traversing a road segment within a specific time window push their respective brake pedals within a specific relatively small section of—at a specific mile marker or within a specific range on—the road segment to cause the vehicles to be within an applicable speed limit on the road segment.

### 3.3. Speed Check Data Analyses

Multiple speed check algorithms may be implemented using ML-based or non-ML techniques and applied to different types of input or collected data to generate predictions of speed check zones or events with a relatively high confidence level.

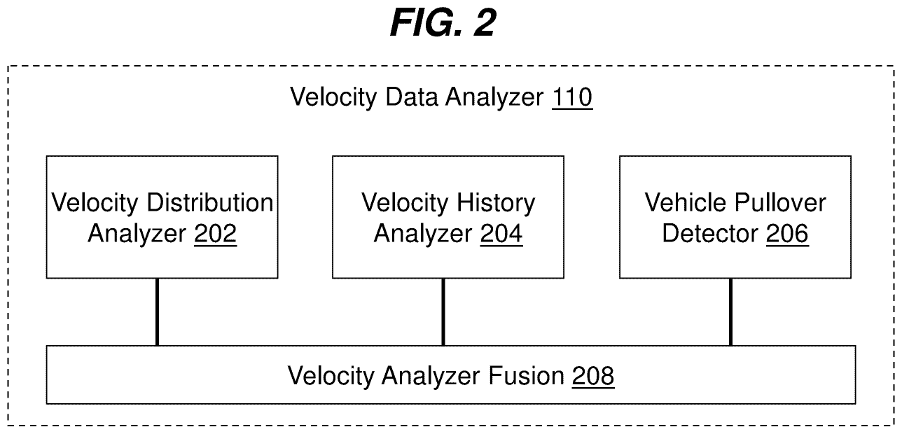

FIG. 2 illustrates an example velocity data analyzer 110 that may be used to perform multiple analyses with respect to input or collected velocity related data for a given (e.g., each in some or all road segments of one or more roads, etc.) road segment within a given time interval (e.g., each in some or all time intervals aggregated into relatively large time such as days, weeks, months, etc.).

The velocity related data may indicate one or more vehicles travel or traversed on the road segment in the time interval. The velocity related data received by the velocity data analyzer 110 may include each vehicle's GPS locations/coordinates, velocities, vehicle heading directions, map matched data, etc.

GPS locations/coordinates, velocities, vehicle heading directions including timing information may be collected from or shared with mobile or non-mobile applications (e.g., MapBox, Apple Maps, etc.) running on in-vehicle mobile devices or built-in computing devices located in the vehicles. By comparison with other types (e.g., manual input, etc.) of collected data, the collected velocity related data may include a relatively large number or set of data or data points.

Map matched data may include, but are not necessarily limited to only, relatively static predictive street data (PSD) received by the backend system implementing the framework 100 from one or more map data providers/systems using PSD protocol operations. The PSD may include road or street type, road geometry or graph, speed limit, etc. PSD protocol. Road or street type may indicate whether a road segment belongs to a highway or a city street. Road geometry or graph in the PSD may indicate a (e.g., certain, probable, etc.) normal traveling direction on a road segment and may be represented in a standard (map or Earth) coordinate system. The road geometry or graph can be transformed from the standard coordinate system to a vehicle-stationary or vehicle-relative coordinate system such as one that may be overlaid with a displayed map in an in-vehicle map or navigation application/system.

As illustrated in FIG. 2, the velocity data analyzer 110 may include a velocity distribution analyzer 202, a velocity history analyzer 204, a vehicle pullover detector 206, a velocity analyzer fusion block/module 208, and so on.

The velocity distribution analyzer 202 can be used to analyze distributions of velocities at different locations of the road segment and detect whether a relatively high number (e.g., by comparison with a vehicle number or percentage threshold, to be configured, to be learned or trained, etc.) of vehicles are driving close to a speed limit applicable to the road segment for a certain amount (e.g., by comparison with a distance threshold, to be configured, to be learned or trained, etc.) of distance. Depending on results of the velocity distribution analysis, the velocity distribution analyzer 202 can make a specific prediction of a presence of a speed check zone or event with a specific confidence level (or confidence level range). While only one vehicle doing this may correspond to a relatively low confidence level, the more the vehicles on the road segment behave like this, the higher the confidence level of the prediction.

The velocity history analyzer 204 can be used to analyze histories of velocities of one or more vehicles traversing the road segment and detect whether a relatively high number (e.g., by comparison with a vehicle number or percentage threshold, to be configured, to be learned or trained, etc.) of vehicles are driving above the speed limit before a specific location in the road segment or prior road segment(s) and reduced the velocities to close to the speed limit at the specific location. The speed or velocity history of each individual vehicle represented in the velocity related data may be analyzed and compared to its previous driving behavior or speed velocity. In response to detecting a pattern that each of one or more vehicles slows down to or close to the speed limit and drove faster before, the velocity history analyzer 204 can make a specific prediction of a presence of a speed check zone or event with a specific confidence level (or confidence level range). While only one vehicle doing this may correspond to a relatively low confidence level, the more the vehicles on the road segment behave like this, the higher the confidence level of the prediction.

The vehicle pullover analyzer 206 can be used to analyze histories of velocities and locations of one or more vehicles traversing the road segment and detect whether there is any vehicle that is pulled over on the shoulder of the road segment or an exit ramp before reaching the next road. For example, in response to determining, based on a history of velocities and locations of a vehicle, that the vehicle droved greater than 10 mph over the speed limit on this or previous road segment(s) but slows down to zero (0) mph in a relatively short amount of time and then starts driving again after a time lapse (e.g., a few minutes, etc), the vehicle pullover analyzer 206 may determine that the likelihood the vehicle got pulled out or pull over by a police officer is relatively high. Hence, a prediction of a presence of a speed check event or zone on the road segment may be made with a relatively high confidence level.

Some or all of these predictions made by the velocity distribution analyzer 202, velocity history analyzer 204 and the vehicle pullover detector 206 may be compared to (user) community reported speed check zones or events for training, validating or correlating purposes. For example, community reported speed check zones or events can be used as ground truths to determine whether the predictions made by the velocity distribution analyzer 202, velocity history analyzer 204 and the vehicle pullover detector 206 are correct, and how likely or confident these predictions are correct.

As illustrated in FIG. 2, the velocity data analyzer 110 may include a velocity analyzer fusion to fuse or aggregate the individual predictions from made by the velocity distribution analyzer 202, velocity history analyzer 204 and the vehicle pullover detector 206 into an overall prediction with an overall confidence level.

The velocity data analyzer 110 can assign different weights to the individual predictions from made by the velocity distribution analyzer 202, velocity history analyzer 204. These weights may be pre-assigned or dynamically configurable. Additionally, optionally or alternatively, these weights may be learned or trained to generate the overall prediction with a relatively high overall confidence level.

Additionally, optionally or alternatively, individual or overall predictions as described herein with respect to speed check zones or events can be validated or checked with realtime or near realtime traffic data and local hazard warnings to exclude erroneous predictions attributed to non-speed check traffic or hazard events or conditions.

The manual input (data) analyzer 112 may be used to perform analyses with respect to input or collected manual input data for a given (e.g., each in some or all road segments of one or more roads, etc.) road segment within a given time interval (e.g., each in some or all time intervals aggregated into relatively large time such as days, weeks, months, etc.).

The manual input data may include (user report) data specifying user inputs received from users of the vehicles through in-vehicle human machine interfaces (or man machine interfaces) implemented by computer applications and systems deployed in the vehicles or reporting functions implemented in these in-vehicle computer applications and systems. For example, a user of a vehicle traversing on the road segment in the timer interval or preceding time interval(s) can report a speed check zone or event on the road segment or preceding road segment(s) by either pushing a button on a screen or a display page or by using a voice (activated) command. A relatively large number (e.g., two, three or more, etc.) users of vehicles manually report a speed check zone or event for the road segment and for the time interval leads to assigning a relatively high confidence level to the reported speed check zone or event for the road segment and for the time interval.

For example, a user of a vehicle may report police presence or sighting by (e.g., in realtime or near realtime, dynamically without waiting, etc.) pushing the button, which can be forwarded to the backend system implementing the framework 100. The backend system can register these user events or reports, positively identify a presence of a speed check zone or event, and distribute alerts or messages to some or all vehicles operating on or approaching the road segment for warning.

It should be noted that, in various operational scenarios, manual inputs as described herein may not be limited to speed check only. For example, a user of a vehicle may report abnormal traffic conditions or hazards/dangers by pushing applicable user interface controls. Corresponding user inputs can be collected and/or forwarded to the backend system implementing the framework 100. The backend system can register these user events or reports, determine or validate the observed conditions/hazards/dangers not relating to speed check, and distribute alerts or messages to some or all vehicles operating on or approaching the road segment for information or for warning.

The image (recognition) data analyzer 112 may be used to perform analyses with respect to input or collected image related data for a given (e.g., each in some or all road segments of one or more roads, etc.) road segment within a given time interval (e.g., each in some or all time intervals aggregated into relatively large time such as days, weeks, months, etc.).

The image related data may include image recognition data indicating police presence, speed check activities, abnormal traffic conditions/hazards, etc., that are recognized from image or range data collected with in-vehicle cameras or image/range sensors through ML-based and/or non-ML computer vision techniques. In some operational scenarios, at least some of the image related data such as image recognition data may be first collected by in-vehicle applications/systems through in-vehicle CANs, ETH, FR, LIN, MOST, CANFD, processed with in-vehicle image/range data analyses by the in-vehicle applications/systems, and then uploaded to the backend system implementing the framework 100. Hence, (e.g., external, etc.) cameras or image/range sensors of the vehicles may be used to acquire realtime or near realtime image/range data. The image/range data can be analyzed with the computer vision techniques (e.g., convolutional neural networks, etc.) to recognize police cars on the street or other reportable events/conditions, to differentiate between a stationery vehicle and a moving vehicle, etc. A relatively high confidence level may be assigned to a prediction of a speed check zone or event on the road segment in the time segment in response to determining that a (moving or stationary) police car is present nearby.

The braking (behavior) data analyzer 114 may be used to perform analyses with respect to input or collected braking related data for a given (e.g., each in some or all road segments of one or more roads, etc.) road segment within a given time interval (e.g., each in some or all time intervals aggregated into relatively large time such as days, weeks, months, etc.).

The braking related data may include specific braking (behavior) patterns of (users of) vehicles indicating police presence, speed check activities, abnormal traffic conditions/hazards, etc., and may be collected or generated with in-vehicle applications/systems. In some operational scenarios, at least some of the braking related data may be first collected by in-vehicle applications/systems through in-vehicle CANs, processed with in-vehicle braking (behavior) data analyses by the in-vehicle applications/systems, and then uploaded to the backend system implementing the framework 100. For example, if a user (or driver/operator) of a vehicle observes police vehicle presence or speed check activities, the user tends to push the brake suddenly for a relatively short amount of time. ML-based braking behavior algorithms may be implemented to learn or recognize this braking pattern in a training phase and apply to detect the pattern in an application phase for the purpose of identifying or predicting speed check zones or events.

### 3.4. Speed Check Detection

The data analyzers as described herein may be implemented or trained to recognize more uniform vehicle behaviors at specific locations/sectors of road segments and less uniform vehicle behaviors on other specific locations/sectors of the road segments. For example, more uniform behaviors of close to the speed limit—e.g., within a range of three miles (per hour) above and five miles (per hour) below the speed limit—may be observed at locations where there may exist speed check zones or events. In comparison, more varying behaviors with most cars at ten mph more than the speed limit may be observed at other locations where there may not exist speed check zones or events. In response to determining that every vehicle is slowing down below the speed limit, there may be a traffic jam or a road condition instead of any presence of a speed check zone or event. Additionally, optionally or alternatively, the data analyzer may use or consider historic vehicle speeds of vehicles as a reference. If all vehicles on most (e.g., 364, etc.) days travel or drive at 70 mph on a section of road, then this can be used or considered by the data analyzer as a reference or baseline for comparison with the current speeds of vehicles on the section of road. If on a specific day everybody is driving at a different speed such as 65 mph (as opposed to the reference or baseline speed of 70 mph) on the same section of road, then the data analyzer may determine that a speed check zone or event is occurring on that section of road.

FIG. 3B and FIG. 3C illustrate example plots of collected velocity data for speed check detection on a given road segment in a given time interval, where the horizontal axis represents locations (or sectors) of the road segment along a lane direction (or a normal vehicle traveling direction) of the road segment, where the vertical axis represents absolute or relative velocities.

The upper part of FIG. 3B illustrates absolute (or relative to the road segment) speed or velocity data of a plurality of vehicles traversing on the road segment, whereas the lower part of FIG. 3B illustrates relative speed or velocity data of the same plurality of vehicles in reference or relation to a speed limit 314 applicable to the road segment.

The velocity data analyzer 110—or the velocity distribution analyzer 202 and/or the velocity history analyzer 204 therein—may determine, based on the velocity data, that under normal traffic conditions in a sector (on which there is no speed check zone or event) of the road segment, a first distribution 304 of vehicle speeds or velocity normally occurring on road, highway, interstate or the like is observed in a first sector of the road segment. Some vehicles go almost below the speed limit 314, some right around the speed limit 314 and some at above the speed limit 314. Even when there are fluctuations in the speeds/velocities of the vehicles, there variations are of a relatively low frequency that is hardly visible within a relatively small section of a road. For example, the first distribution 304, especially its relative speed counterpart in the lower part of FIG. 3B, can be readily recognized as no speed check in the first sector of the road segment.

If a speed check point or activity on the road segment becomes visible to the users or vehicles traversing the road segment, one or more of these users (or drivers) first spotting the speed check will most likely hit their brake pedals to bring down their speeds or velocities to close to the speed limit 314. Even for some vehicles below or barely above the speed limit 314, their users (or drivers) may join or initiate braking or tap their brake pedals once. Some of the users (or drivers) may ignore or miss the swarm braking entirely because they are not concerned or because they did not notice the speed check and continue at (their previous) constant speeds/velocities. All braking however can be observed to happen in a relatively small sector (or window) of the road segment such as a certain distance to observed police presence or speed check activities. Most users (or drivers) decrease their speeds/velocities to right around the speed limit 314, which may be used to infer or predict a specific start point 306 of a speed check zone or event on the road segment. In some operational scenarios, a safety margin may be incorporated in determining the specific starting point 306 of the speed check zone or event.

After a period of time most users (or drivers) start to increase speeds/velocities of their vehicles again. A specific end point 310 of the speed check zone or event may be inferred or predicted as a specific location of the road segment after which most if not all drivers return to their regular driving behaviors and hence generate a second distribution 312 of speeds/velocities.

FIG. 3C illustrates example x-y locations of the vehicles corresponding to the velocity data of the vehicles as illustrated in FIG. 3B. As in FIG. 3B, the x axis in FIG. 3C represents locations (or sectors) of the road segment along a lane direction (or a normal vehicle traveling direction) of the road segment. The y axis in FIG. 3C represents locations of vehicles in a transverse direction to the lane direction.

The velocity data analyzer 110 or the vehicle pullover detector 206 therein may determine, based on the velocity data (including vehicle locational data correlated with vehicle velocities or speeds), that a vehicle 308 left a normal traffic lane on the road segment, is being pulled over to the right shoulder of the road segment, then reduces its speed to zero. While most vehicle pullovers are to the right of road segments such as illustrated in FIG. 3C, but sometimes vehicles may be pulled over to the left of road segments. The reduced speed pattern among the vehicles traversing the road segment may most likely continue but it is possible that fewer and fewer vehicles reduce their speeds. One or more ML-based and/or non-ML algorithms may be implemented or performed to detect these patterns or behaviors and determine or generate a likelihood (or confidence level) of a presence of a speed check zone or event.

Speed check related data analyses as described herein may be performed on collected or configured data of one or more data types. For example, in analyzing velocity data, collected or configured data relating to road type, speed limit, traffic information, image (recognition) data, manual input data, braking (behavior) data, etc., may be incorporated or used in the same analysis process or algorithm. These different types of data together may be used by the process or algorithm to infer or predict whether there is a speed check zone present at a given road segment and/or whether where is a speed check event present at a given time interval.

For example, images/pictures and/or range data may be acquired by cameras or sensors deployed with a vehicle and analyzed, for example, by in-vehicle image analysis functionality implemented with in-vehicle computer application(s) or system(s). Computer vision techniques such as algorithms relating to object segmentation, object detection, vehicle detection, moving object detection, object proximity, etc. can be implemented with the in-vehicle application(s) or system(s) to analyze the acquired images/pictures and/or range data. For example, an event of vehicle pullover by police may be detected in part or in whole by using some or all of these computer vision techniques. Velocities and proximities of other vehicles or objects including but not limited to police vehicles, pullover vehicles, slowing vehicles, accelerating vehicles, parked cars, speed zones, relative velocities, etc., may be detected by the in-vehicle application(s) or system(s) through analyzing the images/pictures and/or range data acquired with cameras and/or LIDAR or RADAR sensors. Image (recognition) data can be generated/determined and uploaded to the backend system by the in-vehicle application(s) or system(s). For user privacy protection and/or for data volume reduction, the image (recognition) data and/or some or all other types of collected data from vehicles may be anonymized to remove any user identifying information (per applicable laws and regulations, per industry practices) and uploaded to the backend only if certain conditions are met (e.g., a user has given a prior or contemporaneous consent, a police vehicle is detected, a road hazard is detected, etc.).

The uploaded image (recognition) data and/or other types of collected data can be analyzed by the backend system to detect speed check zones or events. For example, slowing down by multiple vehicles with no apparent causes known to the backend system may lead the backend system to predict a presence of a speed check zone or event. A velocity history of a vehicle indicating that the vehicle typically travels ten mph over the speed limit on a highway suddenly slows down to close to the speed limit may lead the backend system to predict a presence of a speed check zone or event. Normal behaviors, for example making phone calls in vehicles or other possible internal events, may also cause the vehicles to slow down at least for a relatively short time. However, if multiple vehicles exhibit the same driving behaviors as detected by the backend system, the backend system may determine that vehicle slowing downs are external events and may lead to a prediction of a presence of a speed check zone or event.

Braking (behavior) data such as super-surprise braking behavior or relatively sharp slowing down may be recognized by a machine learned algorithm implemented by the backend system as a pattern indicating a presence of a speed check zone or event. The algorithm may be trained beforehand to generate optimized operational parameters to minimize prediction errors.

Additionally, optionally or alternatively, a machined learned algorithm implemented by the backend system may be used to detect that a vehicle slowing down and not moving for a relatively long time. This may be recognized by the algorithm as a car breakdown, rather than a presence of a speed check zone or event. If the vehicle stops only for a couple of minutes, this may be recognized by the ML algorithm as a temporary event unrelated to speed check. If the vehicle stops for more minutes, this may be recognized by the ML algorithm as a temporary event related to speed check such as a vehicle pullover event. Whether a temporary event is a normal behavior unrelated to speed check or not may be learned in a training phase by the ML algorithm using training data with ground truth labels indicating whether a training sample relates to speed check or not. Optimized operational parameters may be deployed with the same ML algorithm in an application phase to make predictions of speed check zones/events or non-speed-check zone/events with corresponding confidence levels.

The precision of start and end locations of the speed check zone (which may cover more than one road segment) and/or the precision of start and end times of the speed check event (which may cover more than one time interval) may depend on spatial and/or temporal resolution or granularity (e.g., every three or five minutes, every fifteen minutes, time correlated locational information every few meters or every few tens of meters, etc.) of the collected data.

As noted, multiple ML-based or non-ML algorithms may be implemented by the backend system to improve precision or increase confidence levels of predictions generated by the backend system. For example, manual reporting or manual inputs may be used by these algorithms to generate predictions or correlated with predictions generated from other types of data. In some operational scenarios, users of vehicles may be asked to verify predictions automatically generated by the backend system. User validations or invalidations of some or all of these predictions may be used to improve or train some of these algorithms in realtime or in an offline environment. In some operational scenarios, the predictions can be checked by the backend system with local hazards or conditions. For example, if there is a traffic jam or construction zone, some or all predictions of speed check zones may be excluded or automatically invalidated by the backend system. Hence, while some or all of these algorithms may be able to generate individual predictions with individual confidence levels, these predictions may be combined or aggregated by ML-based and/or non-ML analysis/prediction fusion functionality implemented by the backend to generate predictions with relatively high confidence levels.

### 4.0. Example Process Flows

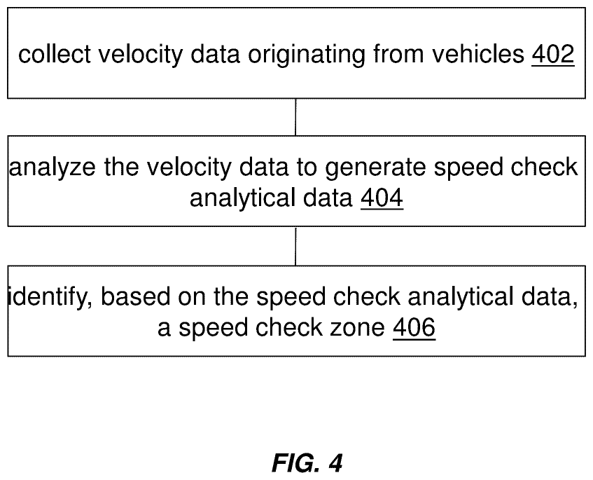

FIG. 4 illustrates an example process flow 400 according to an embodiment. In some embodiments, one or more computing devices or components may perform this process flow. In block 402, a system as described herein collects one or more sets of velocity data originating from one or more vehicles traversing a road segment, each set of velocity data in the one or more sets of velocity data originating from a respective vehicle in the one or more vehicles;

In block 404, the system analyzes the one or more sets of velocity data to generate speed check analytical data for the road segment.

In block 406, the system identifies, based at least in part on the speed check analytical data, a speed check zone on the road segment.

In an embodiment, the one or more sets of velocity data are derived from sensor data with physical sensors deployed in the one or more vehicles within a specific time window.

In an embodiment, the system is further configured to perform: collecting one or more sets of manual input data are derived from user interaction data generated in the one or more vehicles traversing the road segment.

In an embodiment, the one or more sets of manual input data are analyzed to generate second speed check analytical data for the road segment; wherein the speed check zone is identified based further on the second speed check analytical data.

In an embodiment, the system is further configured to perform: collecting one or more sets of image related data generated in the one or more vehicles traversing the road segment. The one or more sets of image related data are analyzed to generate second speed check analytical data for the road segment; wherein the speed check zone is identified based further on the second speed check analytical data

In an embodiment, the system is further configured to cause a vehicle—e.g., through user perceivable warnings on a map or navigation application, etc.—to adjust its speed to be at or under a maximum speed for that road segment when entering the speed check zone.

In an embodiment, the system is further configured to perform: collecting one or more sets of braking behavior data generated in the one or more vehicles traversing the road segment.

In an embodiment, the one or more sets of braking behavior data are analyzed to generate second speed check analytical data for the road segment; wherein the speed check zone is identified based further on the second speed check analytical data.

In an embodiment, the system is further configured to perform: providing warning data that identifies the speed check zone to at least one vehicle that is to traverse the road segment.

In an embodiment, the speed check analytical data relates to one or more of: one or more speed distributions at one or more locations of the road segment, one or more speed histories of the one or more vehicles traversing the road segment, a vehicle diversion and stopping outside driving lanes of the road segment, etc.

In an embodiment, a computing device is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Other examples of these and other embodiments are found throughout this disclosure. Note that, although separate embodiments are discussed herein, any combination of embodiments and/or partial embodiments discussed herein may be combined to form further embodiments.

### 5.0. Implementation Mechanism-Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

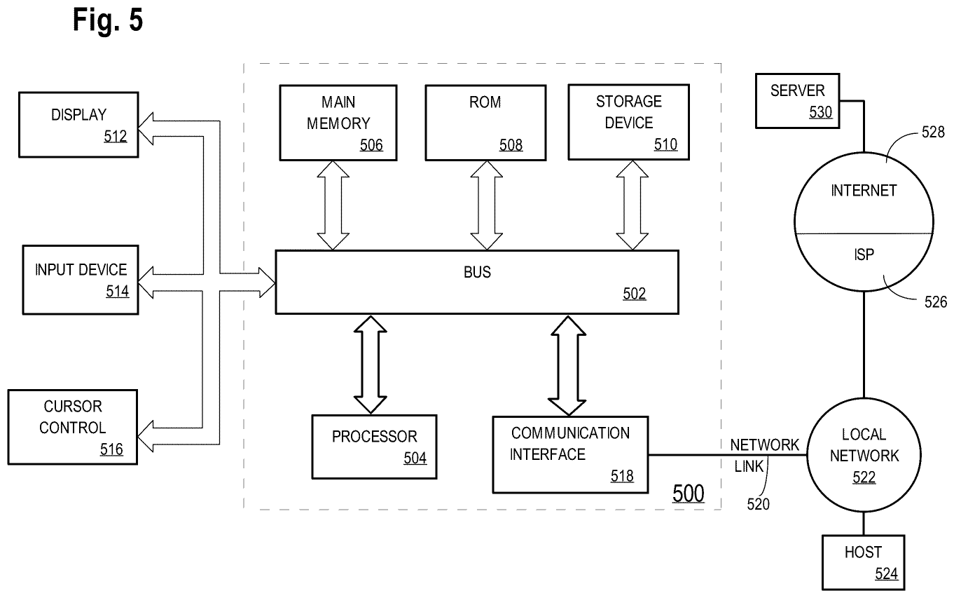

FIG. 5 is a block diagram that illustrates a computer system 500 utilized in implementing the above-described techniques, according to an embodiment. Computer system 500 may be, for example, a desktop computing device, laptop computing device, tablet, smartphone, server appliance, computing main image, multimedia device, handheld device, networking apparatus, or any other suitable device.

Computer system 500 includes one or more busses 502 or other communication mechanism for communicating information, and one or more hardware processors 504 coupled with busses 502 for processing information. Hardware processors 504 may be, for example, a general purpose microprocessor. Busses 502 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 500 also includes a main memory 506, such as a random access memory (RAM) or other dynamic or volatile storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes one or more read only memories (ROM) 508 or other static storage devices coupled to bus 502 for storing static information and instructions for processor 504. One or more storage devices 510, such as a solid-state drive (SSD), magnetic disk, optical disk, or other suitable non-volatile storage device, is provided and coupled to bus 502 for storing information and instructions.

Computer system 500 may be coupled via bus 502 to one or more displays 512 for presenting information to a computer user. For instance, computer system 500 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 512 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 512.

In an embodiment, output to display 512 may be accelerated by one or more graphics processing unit (GPUs) in computer system 500. A GPU may be, for example, a highly parallelized, multi-core floating point processing unit highly optimized to perform computing operations related to the display of graphics data, 3D data, and/or multimedia. In addition to computing image and/or video data directly for output to display 512, a GPU may also be used to render imagery or other video data off-screen, and read that data back into a program for off-screen image processing with very high performance. Various other computing tasks may be off-loaded from the processor 504 to the GPU.

One or more input devices 514 are coupled to bus 502 for communicating information and command selections to processor 504. One example of an input device 514 is a keyboard, including alphanumeric and other keys. Another type of user input device 514 is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. Yet other examples of suitable input devices 514 include a touch-screen panel affixed to a display 512, cameras, microphones, accelerometers, motion detectors, and/or other sensors. In an embodiment, a network-based input device 514 may be utilized. In such an embodiment, user input and/or other information or commands may be relayed via routers and/or switches on a Local Area Network (LAN) or other suitable shared network, or via a peer-to-peer network, from the input device 514 to a network link 520 on the computer system 500.

A computer system 500 may implement techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 500 can receive the data on the network and demodulate the signal to decode the transmitted instructions. Appropriate circuitry can then place the data on bus 502. Bus 502 carries the data to main memory 505, from which processor 504 retrieves and executes the instructions. The instructions received by main memory 506 may optionally be stored on storage device 510 either before or after execution by processor 504.

A computer system 500 may also include, in an embodiment, one or more communication interfaces 518 coupled to bus 502. A communication interface 518 provides a data communication coupling, typically two-way, to a network link 520 that is connected to a local network 522. For example, a communication interface 518 may be an integrated services digital network (ISDN) card, cable modem, satellite modem, or a modem to provide a data communication connection to a corresponding type of telephone line. As another example, the one or more communication interfaces 518 may include a local area network (LAN) card to provide a data communication connection to a compatible LAN. As yet another example, the one or more communication interfaces 518 may include a wireless network interface controller, such as a 802.11-based controller, Bluetooth controller, Long Term Evolution (LTE) modem, and/or other types of wireless interfaces. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by a Service Provider 526. Service Provider 526, which may for example be an Internet Service Provider (ISP), in turn provides data communication services through a wide area network, such as the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

In an embodiment, computer system 500 can send messages and receive data, including program code and/or other types of instructions, through the network(s), network link 520, and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. As another example, information received via a network link 520 may be interpreted and/or processed by a software component of the computer system 500, such as a web browser, application, or server, which in turn issues instructions based thereon to a processor 504, possibly via an operating system and/or other intermediate layers of software components.

In an embodiment, some or all of the systems described herein may be or comprise server computer systems, including one or more computer systems 500 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 6.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the disclosure have been described with reference to numerous specific details that may vary from implementation to implementation. Thus, the sole and exclusive indicator of what is the disclosure, and is intended by the applicants to be the disclosure, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
collecting one or more sets of velocity data originating from one or more vehicles traversing a road segment, each set of velocity data in the one or more sets of velocity data corresponding to a respective vehicle in the one or more vehicles;
analyzing the one or more sets of velocity data to generate speed check analytical data for the road segment;
identifying, based at least in part on the speed check analytical data, a speed check zone on the road segment.

2. The method of claim 1, wherein the one or more sets of velocity data are derived from sensor data with physical sensors deployed in the one or more vehicles within a specific time window.

3. The method of claim 1, further comprising: collecting one or more sets of manual input data are derived from user interaction data generated in the one or more vehicles traversing the road segment.

4. The method of claim 3, wherein the one or more sets of manual input data are analyzed to generate second speed check analytical data for the road segment; wherein the speed check zone is identified based further on the second speed check analytical data.

5. The method of claim 1, further comprising: collecting one or more sets of image related data generated in the one or more vehicles traversing the road segment, wherein the one or more sets of image related data are analyzed to generate second speed check analytical data for the road segment; wherein the speed check zone is identified based further on the second speed check analytical data.

6. The method of claim 1, further comprising: causing a vehicle to adjust its speed to be at or under a maximum speed for that road segment when entering the speed check zone.

7. The method of claim 1, further comprising: collecting one or more sets of braking behavior data generated in the one or more vehicles traversing the road segment.

8. The method of claim 7, wherein the one or more sets of braking behavior data are analyzed to generate second speed check analytical data for the road segment; wherein the speed check zone is identified based further on the second speed check analytical data.

9. The method of claim 1, further comprising: providing warning data that identifies the speed check zone to at least one vehicle that is to traverse the road segment.

10. The method of claim 1, wherein the speed check analytical data relates to one or more of: one or more speed distributions at one or more locations of the road segment, one or more speed histories of the one or more vehicles traversing the road segment, or a vehicle diversion and stopping outside driving lanes of the road segment.

11. A system, comprising: one or more computing processors; one or more non-transitory computer readable media storing a program of instructions that is executable by the one or more computing processors to perform:
collecting one or more sets of velocity data originating from one or more vehicles traversing a road segment, each set of velocity data in the one or more sets of velocity data corresponding to a respective vehicle in the one or more vehicles;
analyzing the one or more sets of velocity data to generate speed check analytical data for the road segment;
identifying, based at least in part on the speed check analytical data, a speed check zone on the road segment.

12. The system of claim 11, wherein the one or more sets of velocity data are derived from sensor data with physical sensors deployed in the one or more vehicles within a specific time window.

13. The system of claim 11, wherein the program of instructions is executable by the one or more computing processors to further perform: collecting one or more sets of manual input data are derived from user interaction data generated in the one or more vehicles traversing the road segment.

14. The system of claim 13, wherein the one or more sets of manual input data are analyzed to generate second speed check analytical data for the road segment; wherein the speed check zone is identified based further on the second speed check analytical data.

15. The system of claim 11, wherein the program of instructions is executable by the one or more computing processors to further perform: collecting one or more sets of image related data generated in the one or more vehicles traversing the road segment; wherein the one or more sets of image related data are analyzed to generate second speed check analytical data for the road segment; wherein the speed check zone is identified based further on the second speed check analytical data.

16. The system of claim 11, wherein the program of instructions is executable by the one or more computing processors to further perform: causing a vehicle to adjust its speed to be at or under a maximum speed for that road segment when entering the speed check zone.

17. The system of claim 11, wherein the program of instructions is executable by the one or more computing processors to further perform: collecting one or more sets of braking behavior data generated in the one or more vehicles traversing the road segment.

18. The system of claim 17, wherein the one or more sets of braking behavior data are analyzed to generate second speed check analytical data for the road segment; wherein the speed check zone is identified based further on the second speed check analytical data.

19. The system of claim 11, wherein the program of instructions is executable by the one or more computing processors to further perform: providing warning data that identifies the speed check zone to at least one vehicle that is to traverse the road segment.

20. The system of claim 11, wherein the speed check analytical data relates to one or more of: one or more speed distributions at one or more locations of the road segment, one or more speed histories of the one or more vehicles traversing the road segment, or a vehicle diversion and stopping outside driving lanes of the road segment.

21. One or more non-transitory computer readable media storing a program of instructions that is executable by one or more computing processors to perform:
collecting one or more sets of velocity data originating from one or more vehicles traversing a road segment, each set of velocity data in the one or more sets of velocity data corresponding to a respective vehicle in the one or more vehicles;
analyzing the one or more sets of velocity data to generate speed check analytical data for the road segment;
identifying, based at least in part on the speed check analytical data, a speed check zone on the road segment.
